(19) United States
(12) Patent Application Publication
(10) Pub. No.: US 2007/0201412 A1
(43) Pub. Date: Aug. 30, 2007

(54) Protocol for improved utilization of a wireless network using interference estimation

(76) Inventors: Lusheng Ji, Randolph, NJ (US); Jonathan Russell Agre, Brinklow, MD (US); Tamer Nadeem, Plainsboro, NJ (US); Ashok Agrawala, Ashton, MD (US)

Correspondence Address: STAAS & HALSEY LLP, SUITE 700, 1201 NEW YORK AVENUE, N.W., WASHINGTON, DC, 20005, US

(21) Appl. No.: 11/363,208

(22) Filed: Feb. 28, 2006

(51) Int. Cl. H04Q 7/24

(52) U.S. Cl. 370/338

(57) ABSTRACT

Disclosed is a protocol used by wireless stations sharing a single wireless channel. When a local station senses a communication between remote stations using the channel, the local station estimates whether its local transmissions would disrupt this on-going remote communication. To estimate, the local station forms capture models of the remote stations. From the capture models, the local station determines if its local transmission would prevent each remote station from capturing the signal from the other remote station. If the local transmission would not disrupt the remote communications, the local station transmits its message over the channel at the same time the remote stations use the channel. The local station performs the estimation using parameters of the remote stations. The stations could share their parameters by including them in headers of frames. The protocol can be implemented as an enhancement to the IEEE 802.11 standard.

### BACKGROUND OF THE INVENTION

1. Field of the Invention

The present invention pertains to wireless communication. More specifically, the present invention relates to methods of sharing a wireless communication channel.

2. Description of the Related Art

As the success of the Internet shows, computers are far more useful when they can communicate with other computers. A group of computers that can share information is known as a computer network. FIG. 1a illustrates a typical example of a computer network, 2. Network 2 has seven devices, which includes server computer 4, desktop computers 8, 10, and 12, laptop computer 14, and printer 6. Each device has networking equipment, 4a-14a. The networking equipment allows each device to transmit signals over a channel, 20. In this example, channel 20 is made of one or more wires.

In a computer network, each device is identified by a unique address. This is similar to the way the postal system identifies each home in a neighborhood by assigning the home a mailing address, or the way telephones are given unique telephone numbers. The address given to a device in the type of computer network shown in FIG. 1a is known as a medium access control address (“MAC address”) or a data link control address (“DLC address”). For example, in network 2, the MAC address of printer 6 might be the number 0005, while desktop computer 12 might have a MAC address of 0007.

In a computer network, each message transmitted to another device is called a “frame”. FIG. 1b is a timeline showing frames sent between computer 12 and printer 6. Computer 12 begins by sending frame A to printer 6. Printer 6 responds by sending computer 12 frame B. As shown by the timeline, the devices continue sending frames in this manner until each device has sent everything it needs to send to the other device. Frames X and Y are the final two frames of the communication.

FIG. 1c shows how a device sends a frame to another device. In this case, computer 12 sends frame A to printer 6. The computer sends the frame as an electrical signal, 40, over wire 20. With a broadcast medium such as this, every device connected to the wire will receive or “hear” electrical signal 40. As such, transmitting a message using the wire is similar to yelling a message in a room full of people. To identify printer 6 as the recipient of the frame, computer 12 must include the printer's unique network address in the frame. FIG. 1d illustrates a frame format containing such an address. Part 50 is an entire frame. Part 52 is the beginning of the frame and contains a portion of data called a “header”. Part 54 is the header portion in greater detail. In this example, the header contains fields 61-70 for storing information. Field 63 contains the frame recipient's address; in this case, the frame recipient's address is the printer's address, 0005. Often the header includes the address of the sending device as well. In this case, field 69 contains the frame sender's address, or 0007, the address of computer 12.

FIG. 2a illustrates a different type of network that has become popular in recent years. In this network, there is no wire. Instead, each device contains a radio antenna and a radio receiver/transmitter or “transceiver”. For example, device 84 could be a desktop computer with an add-on card containing a transceiver and antenna. Devices 86 and 94 could be a printer and a laptop computer with the antenna/transceiver either built into the device or added to the device as a plug-in card. Device 88 could be a device dedicated to providing network features. Such a device is referred to by various terms depending on its functionality, such as “wireless router”, “wireless gateway”, “wireless access point”, and other terms. Such devices often also include equipment 88c for communicating over a wire with other devices, such as a desktop computer, 98. The terms “wireless station” and “wireless node” are often used to describe any component having a transceiver and antenna that can communicate over a wireless network. For example, in FIG. 2a, devices 84-94 are all wireless stations. As transceivers and antennas get integrated with more and more components, the number of types of wireless stations expands. For example, engineers have now made stereo equipment and home appliances wireless stations by incorporating into them antennas, transceivers, and functionality for communicating over a wireless network.

FIG. 2b shows a station sending a frame over a wireless network. As in FIG. 1c, computer 92 sends frame A to printer 86. Instead of transmitting an electrical signal over a wire, computer 92 broadcasts a radio signal containing the frame. Signal 100 propagates outward from computer 92 as shown in the figure. The signal's strength or power is strongest near computer 92, but as the distance from computer 92 increases, the signal's power gets weaker and weaker. Whether a remote station can receive or “hear” the signal from computer 92 depends on a number of factors such as the transmitted power, the remote station's distance from computer 92 and the sensitivity of the transceiver in the remote station.

In the example of FIG. 2b, stations 84-90 and 94 are close enough to computer 92 that they will hear signal 100 over the broadcast medium and pick up frame A. Therefore, just as in the wired network, computer 92 must address the frame to printer 86. Because the frame transmitted over the wireless signal is addressed to the printer 86, printer 86 will store the frame and the other stations might disregard the frame.

In wireless networks, such as the one shown in FIGS. 2a and 2b, all the stations transmit signals and receive signals using the same wireless channel or “carrier”. For example, station 92 transmits a frame to station 86 using the same channel that station 84 might use to transmit a frame to station 90. Therefore, if station 92 and station 84 were to transmit at the exact same time, stations 86 and 90 would hear both signals at the same time. This creates a problem because the two signals can interfere with each other. Engineers refer to this problem as a channel access problem, and FIGS. 3a and 3b illustrate the problem in greater detail.

FIG. 3a shows that station 90 can hear frames transmitted from both stations 92 and 84. FIG. 3b is a timeline showing frames transmitted from stations 92 and 84. The first row of the timeline shows station 92 transmitting frames A, B, and C, and the second row shows station 84 transmitting frames X, Y, Z. The third row illustrates what station 90 hears. During the first period of the timeline, stations 92 and 84 never transmit concurrently. However, during the second period, station 84 transmits frame Z at the same time station 92 transmits frame C. The crossed portions of each frame illustrates when the concurrent transmission occurs.

When station 90 hears only a single transmission, as during the first period, the station is usually able to capture the frame without any problems. However, when station 90 hears two signals at the same time, as in the second period, the signals might interfere, causing station 90 to hear only noise. When this occurs, engineers refer to the received noise as a “garbled” signal. They also call the situation a “collision” of the two frames, and say that the frames were “destroyed”.

The modern methods for wireless communication, or “protocols”, such as the popular IEEE 802.11 standards, address the channel access problem in two ways, illustrated in FIGS. 4a-4c. FIG. 4a illustrates a protocol known as Carrier Sense Multiple Access (“CSMA”). When a local station has a frame to send, 110, it first listens to the channel, 112, and determines if any remote stations are currently transmitting, 114. If the local station determines that the channel is idle, the local station transmits its frame, 116. However, if the local station hears a transmission from a remote station, the local station “backs off” or waits until the channel is idle, 118. When the local station determines that the channel is no longer busy, the local station transmits its frame over the channel. This scheme is also known as a physical carrier sensing scheme.

FIGS. 4b and 4c illustrate a second protocol used in the IEEE 802.11 standards. After a local station determines the channel is idle, the local station first transmits a frame to reserve the channel, 120. This frame is known as a “request-to-send” frame (“RTS”), and includes a duration field containing a value representing the duration of time the local station needs to complete the communication. All the remote stations within range of the local stations will hear the RTS frame, 126. Upon hearing the RTS frame, each remote station determines if it is the recipient of the frame, 128, based on the address field in the frame. The recipient remote station will respond with a “clear-to-send” frame (“CTS”), 132, then will await further frames from the local station. The remaining remote stations hearing the RTS will back-off from the channel, 130. To back off, the remaining remote stations will set an internal timer called a network allocation vector (“NAV”) based on the value of the duration field in the RTS frame. This optional channel reservation scheme is also known as a handshaking scheme or as a virtual carrier sensing scheme.

A major drawback to protocols such as CSMA and the optional handshaking scheme is that they allow only one station to use the carrier at a time. Restricting the carrier to only one transmitter at a time limits the utilization of the network, thus reducing the rate that data can flow through the network. There is a need for a channel access protocol that allows better utilization of a wireless network.

### SUMMARY OF THE INVENTION

It is an aspect of the present invention to provide an improved method of operating a wireless station in a wireless network. When a local station needing to use a channel in a wireless network senses an on-going communication between two remote stations, the local station estimates if its transmissions would interfere with the on-going communication. If the station estimates that its local transmissions would not interfere with the on-going communication, the station transmits its signal concurrently with the sensed communication.

To determine whether the local transmissions would interfere with the on-going communication, the local station models the capture effects at a remote station. This model can be based on various parameters, including the capture ratio of the remote station and the powers of signals received at the remote station. A way the local station could acquire these signal powers is by calculating them using a signal propagation model or using received power measurements. The propagation model might take into account the physical locations of stations in the network and the powers at which stations transmit signals.

Stations could acquire the parameters needed for interference estimation in various ways. For example, each station could maintain a memory for storing parameters, and when a user adds or removes a station from the network, the user could update the stored parameters in all the stations. In another embodiment of the present invention, a station includes these parameters in a frame it transmits. When other stations receive the frame, they update their memories based on the newly received parameters. Additionally, the other stations could perform the interference estimation when they update the cached parameters and store the results of the estimation.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1a illustrates a wired computer network.

FIG. 1b illustrates two devices in a network exchanging frames.

FIG. 1c illustrates a device in a wired network transmitting a frame over a channel.

FIG. 1d illustrates a frame format.

FIG. 2a illustrates a wireless network

FIG. 2b illustrates a station in a wireless network transmitting a frame.

FIG. 3a illustrates a wireless station receiving two signals concurrently.

FIG. 3b illustrates a timeline of frames transmitted over a wireless network.

FIG. 4a illustrates a physical carrier sensing method.

FIGS. 4b and 4c illustrate a virtual carrier sensing method.

FIG. 5a illustrates a local wireless station receiving a signal from a remote wireless station.

FIG. 5b illustrates a local wireless station receiving signals from two remote wireless stations.

FIGS. 6a and 6b illustrate wireless stations communicating over a wireless network.

FIG. 7 illustrates a channel access method using interference estimation.

FIGS. 8 and 9 illustrate an interference estimation method in greater detail.

FIG. 10 illustrates an enhanced frame format.

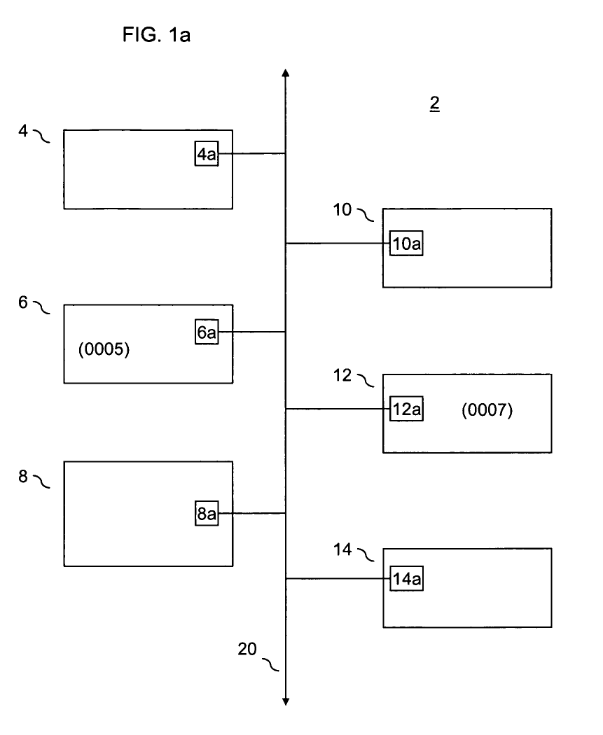

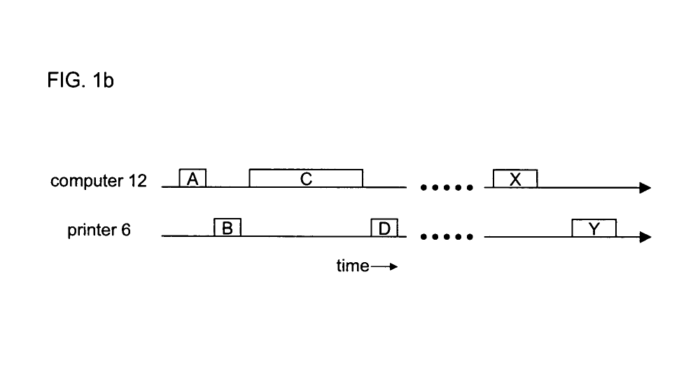

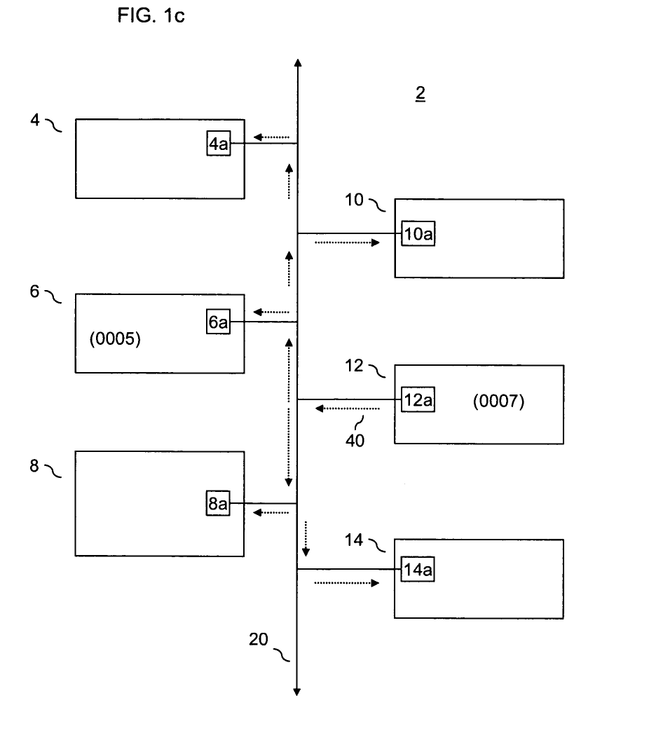

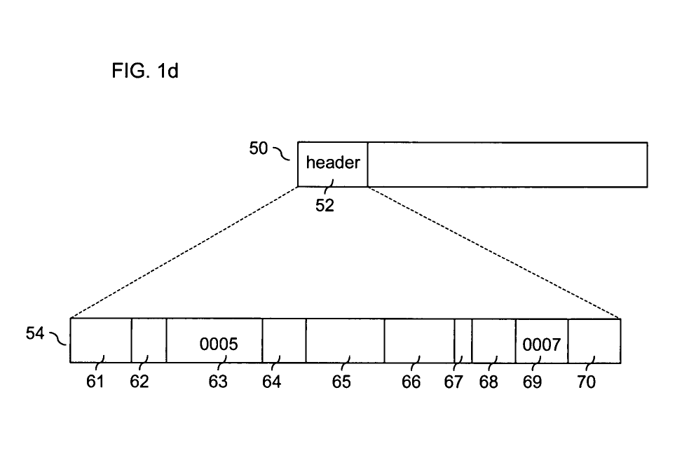

### DETAILED DESCRIPTION OF THE PREFERRED EMBODIMENTS

The present invention is an improved method of operating a wireless station in a wireless network, which can also be referred to as a protocol. The related paper “Location Enhancement to 802.11 DCF” by T. Nadeem, L. Ji, A. Agrawala, and J. Agre, published in IEEE 2005 Infocom, March 2005, Miami, Fla., is hereby incorporated by reference. As the present invention takes the capture effects of a transceiver into consideration, it is appropriate to begin by explaining this phenomenon.

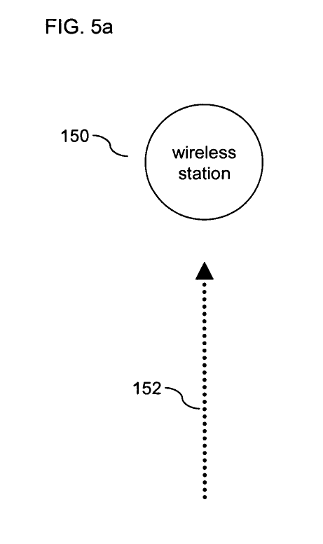

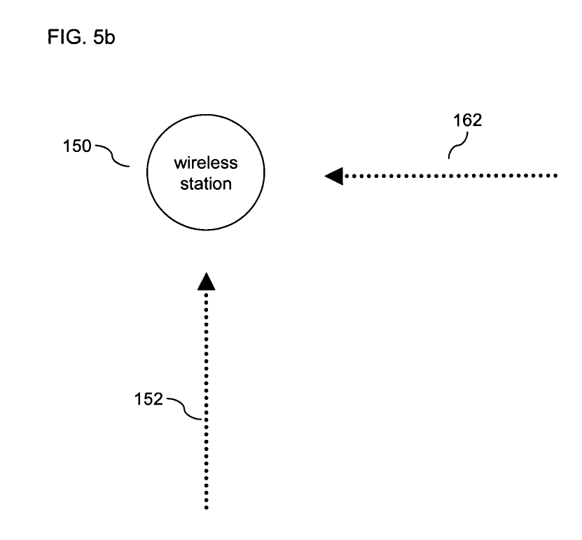

FIG. 5a shows a local wireless station, 150, which is within range of first and second remote wireless stations (not shown). In FIG. 5a, the first remote station is transmitting a signal, 152, carrying a frame addressed to the local station. FIG. 5b illustrates the situation where the second remote station begins transmitting concurrently with the first remote station. Now local station 150 hears two signals, signal 152 from the first remote station and signal 162 from the second remote station.

Transceivers in wireless stations can only capture from a wireless channel one signal at a time. Thus, FIG. 5a illustrates a situation where local station 150 should be able to capture signal 152 and the frame it carries without problems. FIG. 5b, on the other hand, illustrates a situation where local station 150 hears two signals concurrently. In this situation, it is possible that signal 162 might prevent the transceiver from capturing signal 152.

Protocols such as CSMA assume that when a local station, 150, is within range of two remote stations and hears signals from both remote stations at the same time, the local station can not capture either signal. For example, systems using CSMA assume that the situation described in FIG. 5a must be true for a wireless station to receive a signal. Such systems assume that in the situation of FIG. 5b, the second signal, 162, will always prevent local station 150 from capturing signal 152.

The assumption the CSMA protocol is based on is not always true. In reality, hearing two signals at the same time does not always prevent a wireless station from capturing one of the signals. Often the station is able to capture one of the signals and reject the other signal as noise. This behavior is known as the “capture effect”. Engineers have studied the capture effect and generated mathematical models that predict when a receiver can capture one of concurrently transmitted signals and when a receiver will be unable to capture any of concurrently transmitted signals. For example, one of the models holds that a receiver will capture a particular signal if the received power, P_{r,} of that signal is sufficiently larger than the combination of all other signals received. The following equation represents this model:

Pᵣ>α*(P₁+P₂+ . . . +Pₙ₋₁+Pₙ) (1)

where Pᵣ is the received power of a particular signal, P₁ through Pₙ are the received powers of other signals the receiver can hear, and a is a ratio called the “capture ratio” that is unique to the particular transceiver. In other words, as long as the sum of the competing signals is less than Pᵣ/α then the receiver will capture Pᵣ and reject signals P₁ through Pₙ as noise.

Referring again to 5b, assuming the capture ratio of station 150 is α₁₅₀, the power at station 150 of signal 152 is P₁₅₂, and the power at station 150 of signal 162 is P₁₆₂, according to this model, station 150 will capture signal 152 as long as P₁₅₂>α₁₅₀*P₁₆₂.

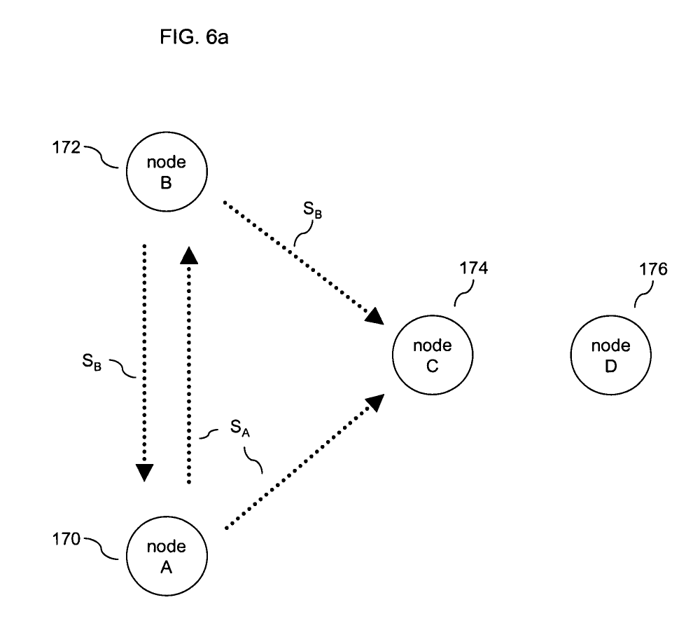

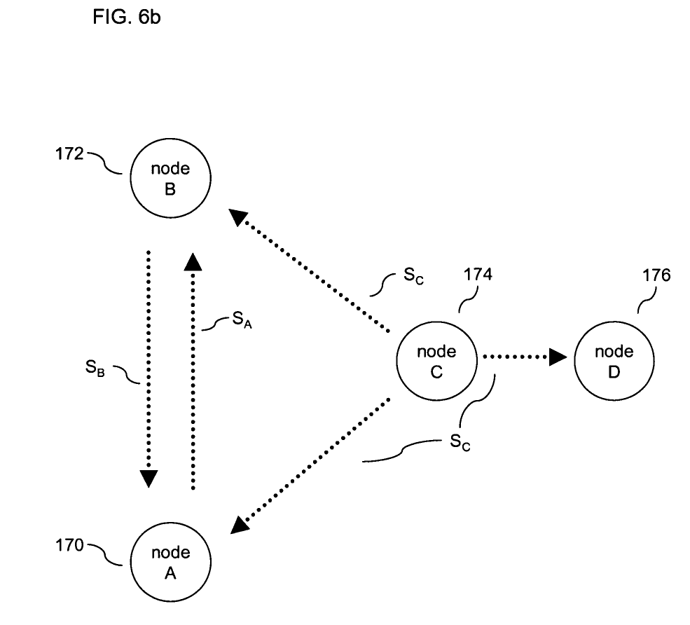

FIGS. 6a and 6b show a wireless network that will be used in describing an embodiment of the present invention. FIG. 6a shows a network of wireless stations that includes station 170 (“Node A”), station 172 (“Node B”), station 174 (“Node C”), and station 176 (“Node D”). All stations use the same wireless channel to send and receive signals.

In FIG. 6a, Node A and Node B use the wireless channel to communicate with each other. Signal S_{A} represents the signals transmitted by Node A, and signal S_{B} represents the signals transmitted by Node B. In this case, Node C is within the range of both Nodes A and B. As such, Node C also receives signals S_{A} and S_{B} transmitted by Nodes A and B. Node D is outside the range of Nodes A and B, and thus, Node D does not hear signals from Nodes A and B.

FIG. 6b illustrates the situation where Node C transmits a signal. Lines S_{C} represent the signal transmitted by Node C. Node C is close enough to Nodes A, B, and D that all three hear S_{C}. As both Nodes A and B can hear signal S_{C} from Node C, it is possible that signal S_{C} could disrupt the communication between Nodes A and B. For example, if Node C were to broadcast concurrently with Node B, Node A would receive signals S_{B} and S_{C} at the same time. Depending on the characteristics of Node A and the characteristics of signals S_{B} and S_{C}, signal S_{C} might prevent Node A from capturing S_{B}. This would constitute a collision and destroy the frame transmitted to Node A from Node B using signal S_{B}.

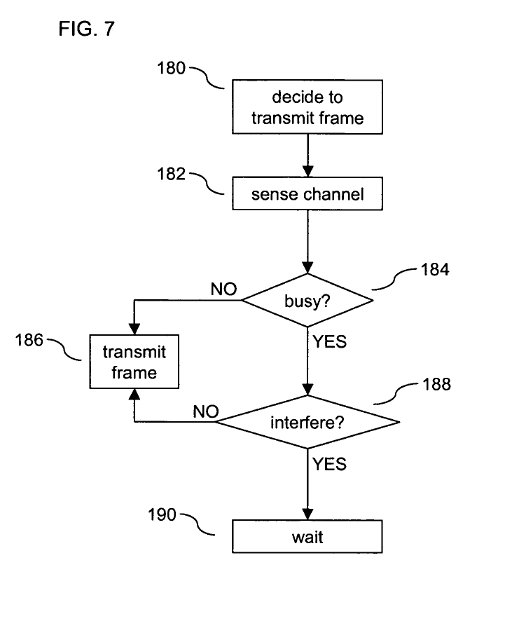

FIG. 7 illustrates an embodiment of the present invention. More particularly, FIG. 7 illustrates a multiple access protocol that increases channel utilization by performing interference estimation. At operation 180, Node C determines that it needs to transmit a frame to remote Node D using the wireless channel. At operation 182 Node C senses the channel. At operation 184, Node C determines whether the channel is in use. If the channel were idle, then Node C would transmit its frame to Node D, 186. However, in the case illustrated by FIGS. 6a and 6b, Node C would sense the communication between Nodes A and B. Note that if the frames transmitted by Nodes A and B include the addresses of both the frame sender and the frame recipient, then Node C can identify both Nodes A and B by receiving only one frame.

Having determined that the channel is busy, Node C then performs an interference estimation, 188, to determine if its local transmissions would interfere with the communication between Nodes A and B. If Node C determines that its local transmission would interfere with the communication between the remote nodes, Node C then waits until the channel is idle before transmitting, 190. However, if Node C determines that its local transmissions would not interfere with the communication between the remote nodes, Node C then transmits its frame using the channel, 186. When Node C transmits after performing an interference estimation, Node C might use the channel at the same time Nodes A or B use the channel.

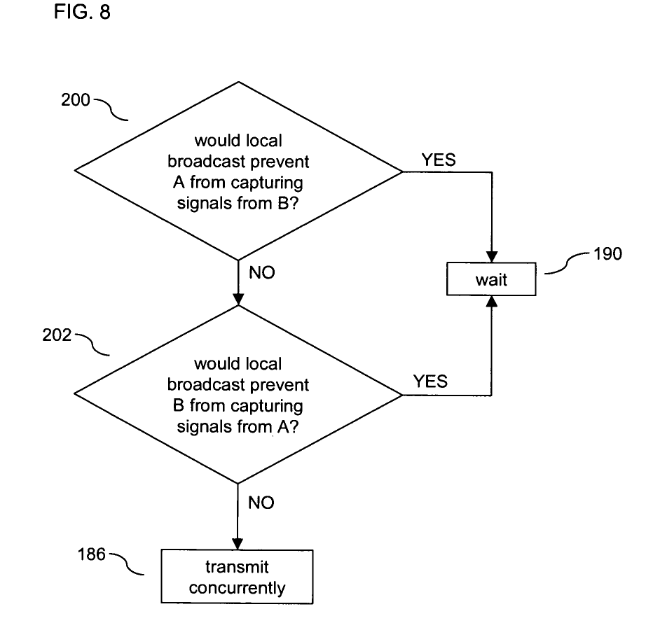

FIG. 8 illustrates in greater detail interference estimation 188. At operation 200 Node C determines if its local transmission, S_{C}, would prevent Node A from capturing signal S_{B}. If Node C determines that S_{C} would prevent Node A from capturing S_{B}, then Node C waits for an idle channel to broadcast, 190. However, if Node C determines that local transmission S_{C} would not prevent Node A from capturing S_{B}, then Node C performs an interference estimation 202 in regards to Node B. Specifically, Node C estimates whether S_{C} would prevent Node B from capturing signal S_{A} from Node A. If Node C determines that a local transmission would prevent Node B from capturing the signal from Node A, then Node C waits until the channel is idle before broadcasting, 190. However, if Node C determines that S_{C} would not prevent Node B from capturing the signal of Node A, then Node C transmits using the channel concurrently with the on-going transmission between Nodes A and B, 186.

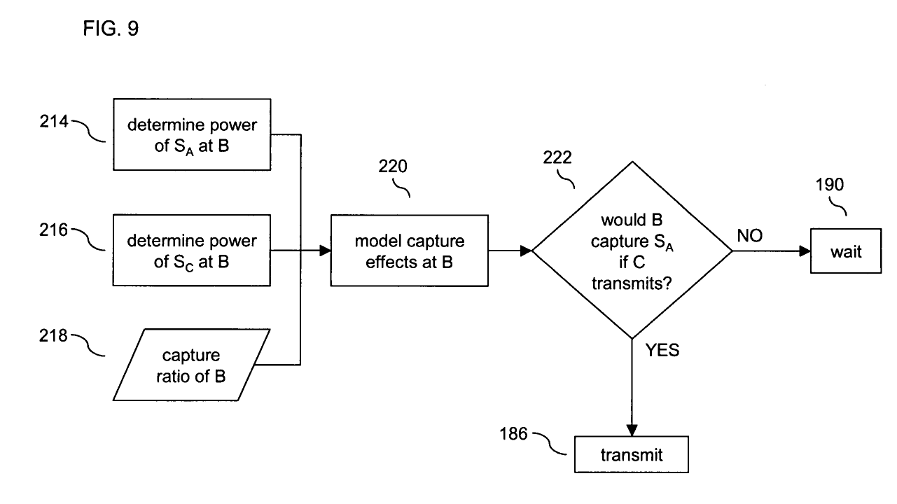

FIG. 9 shows an aspect of operation 202 using the capture effects model presented above. At operation 214 Node C determines the power of signal S_{A} at the location of Node B. At operation 216 Node C determines the power of signal S_{C} at Node B. Based on the capture ratio of Node B, 218, Node C then models the capture effects at Node B, 220. Using the model, Node C then determines if Node B would be able to capture signal S_{A} while also hearing S_{C}.

To model the capture effects at Node B, Node C could employ the capture model presented above as equation (1). In this case, if P_{SA} represents the power of signal S_{A} at Node B, if P_{SC} represents the power of signal S_{C} at the location of Node B, and if α_{B} represents the capture ratio of Node B, then Node C would determine whether P_{SA}>α_{B}* P_{SC}. If P_{SA} was greater than α_{B} times P_{SC}, then Node C could assume that its local transmissions would not prevent Node B from receiving S_{A} and transmit concurrently with Node A. Although this embodiment of the invention employs the model of equation (1), other capture models could be used as well.

In the example of FIG. 9, Node C must acquire the power of signal S_{A} at Node B and the power of signal S_{C} at Node B. If these powers are known at the time the nodes are installed, the powers could be stored in a memory of Node C, and Node C could acquire these powers simply by retrieving them from the memory. However, in other embodiments of the present invention, Node C could acquire these values using a signal propagation model. A variety of different signal propagation models exist, and the particular model used does not effect the operation of the present invention. Therefore, one could design an embodiment of the present invention that has the flexibility of plugging in different propagation models under different operational environments. Furthermore, one might also include measurement based control mechanisms in an open loop fashion so that the model can be better tuned for non-distance induced fading conditions.

The following is an example of a signal propagation model that one could use in this embodiment of the present invention.

$${P}_{r} = \{ \begin{matrix}\frac{{P}_{t} * {G}_{t} * {G}_{r} * {λ}^{2}}{{( 4 * π )}^{2} * {D}^{2} * L} & D \leq {D}_{cross} \\ \frac{{P}_{t} * {G}_{t} * {G}_{r} * {h}_{t}^{2} * {h}_{r}^{2}}{{D}^{4} * L} & D > {D}_{cross}\end{matrix} \qquad ( 2 )$$

In this propagation model Pᵣ is the received signal power, Pₜ is the transmission power, Gₜ is the transmitter antenna gain, Gᵣ is the receiver antenna gain, D is the separation between transmitter and receiver, hₜ is the transmitter elevation, hᵣ is the receiver elevation, L is the system loss factor not related to propagation (≧1), A is the wavelength in meters, and D_{cross} is calculated as D_{cross}=(4*π*hᵣ*hₜ)/γ. The first sub-model of the equation is called the FRIIS Free Space Propagation Model and used when the distance between the transmitter and the receiver is small. The second sub-model is called the two-ray ground reflection model and used when the distance is large.

In addition to waiting when the interference estimate concludes that the local transmission would disrupt an on-going communication between remote stations, a local station should also wait if the recipient of its frame is one of the remote stations engaged in the remote communication. For example, referring to FIG. 6a, assuming that Node C estimates that its local transmissions would not disrupt the on-going communication between Nodes A and B, then Node C could transmit a signal to Node D. However, if Node C attempted to send a frame to either of Nodes A or B, both Node A and Node B would reject the signal from Node C. For this reason, Node C should back off if it determines that the recipient of its frame is a node engaged in a communication.

In order to perform interference estimation, the stations in the network must know characteristics of the other stations in the network. For example, in the embodiment described above, Node C must know the capture ratios of Nodes A and B. Additionally, Node C must have enough knowledge of Nodes A and B to determine the powers of transmissions at these nodes. The stations could acquire this knowledge in various ways. One way could be to store this information in the stations at the time stations are added or removed from the network. Another way could be to have each station share its parameters with other stations in the network by transmitting the parameters in a dedicated parameter sharing message or in every frame transmitted. For example, a station could include parameters in the headers of every frame it transmits. As all stations within range of a transmitting station hear its frames, a benefit of enhancing headers with parameter information is that a station could be configured to process frames not addressed to it for the purpose of learning parameters of other stations in the network. For example, each station could maintain a parameter cache that stores the location, power, and antenna information of already known stations. This way when sending data to a station in cache, the cached parameters may be used in the corresponding header fields instead of null values. Cached entries could be updated if newer information is received from their corresponding stations and could be removed after an expiration time. Sharing parameters in this manner might be particularly.

Various propagation models, such as the one described above, require location information of the transmitting and receiving stations, such as the stations' exact locations or simply a distance between stations. Stations performing interference estimation could acquire such location information in a variety of ways. For example, at installation or removal, the physical location of the station could be determined by the installer and stored in the station. Then the installer could store the location information in the other stations in the network, or the station itself could transmit its location information to the other stations by, for example, adding the information to a frame as explained above.

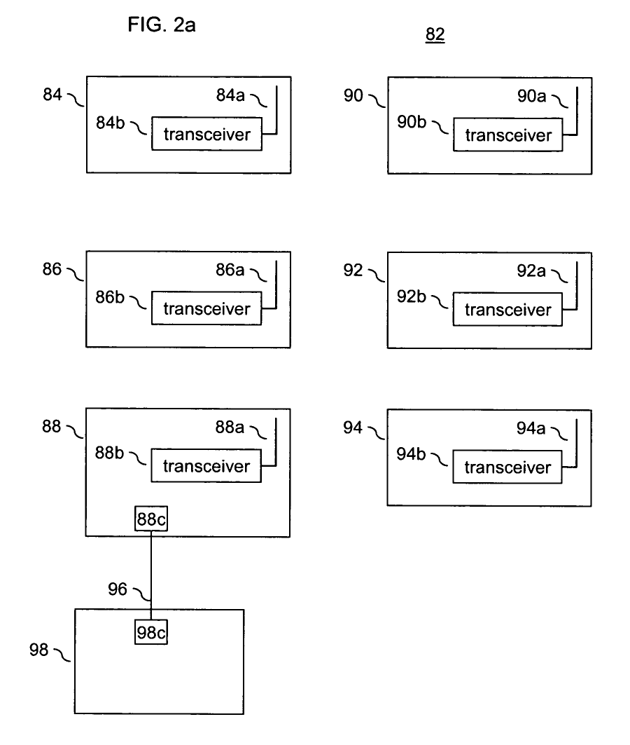

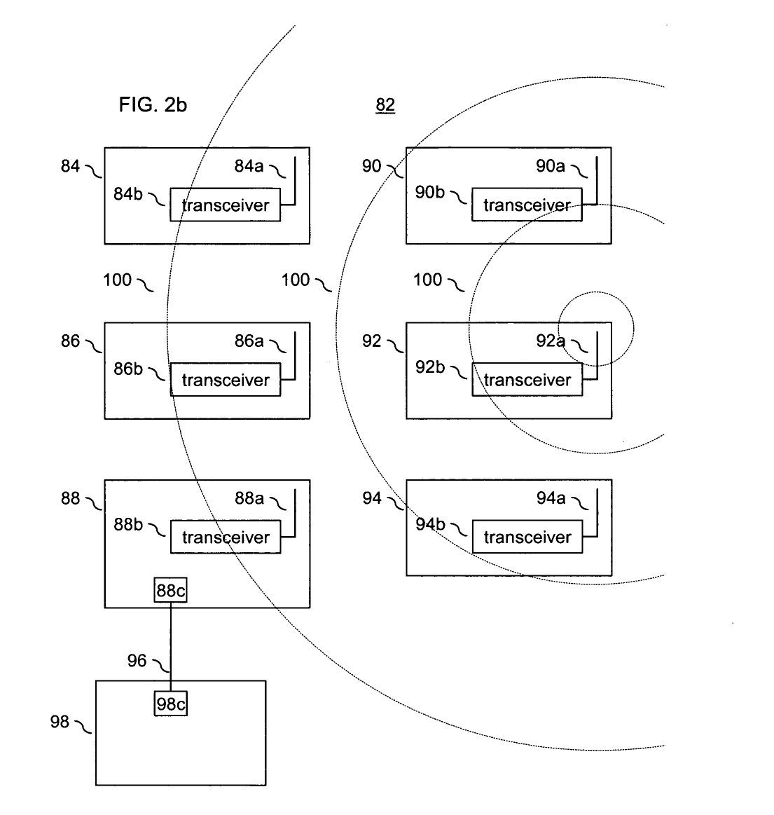

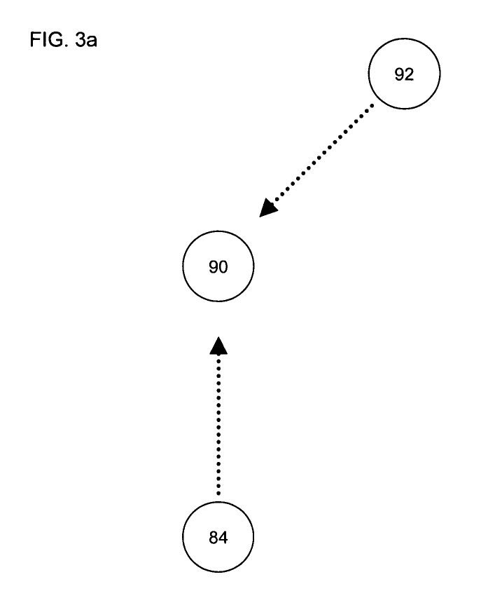

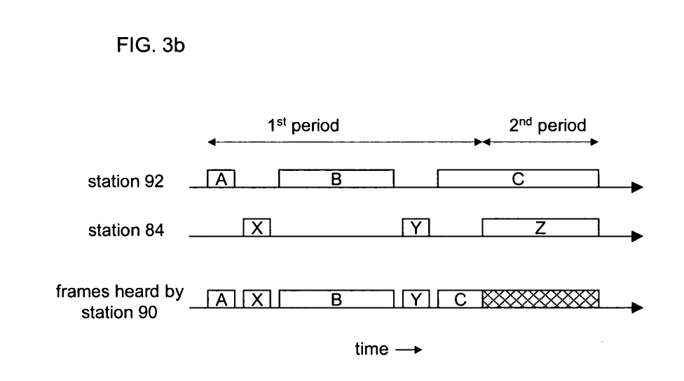

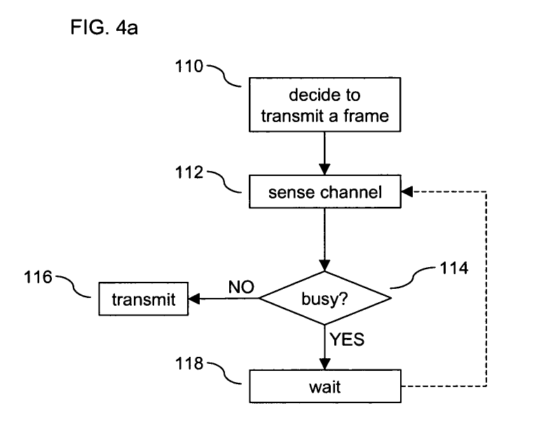

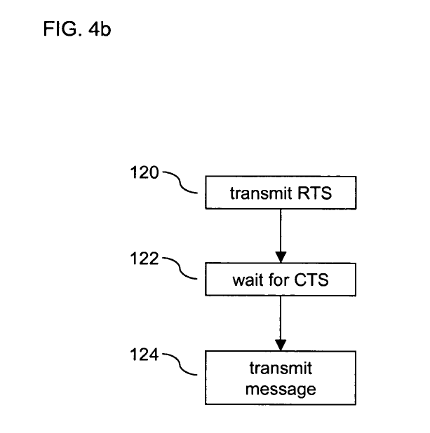

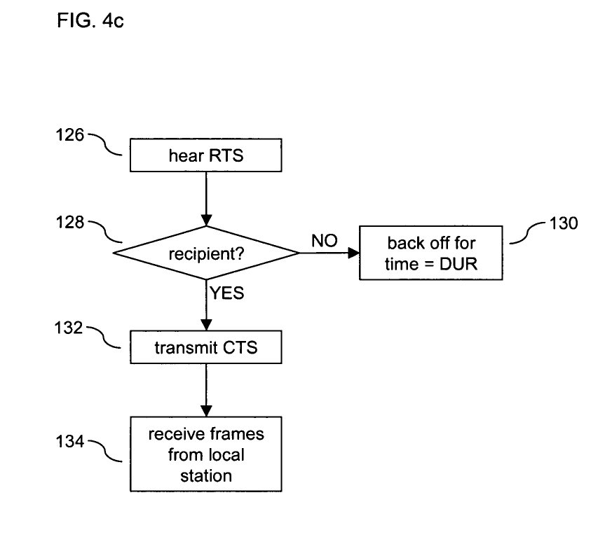

Another way a station could acquire its own location information is using a global positioning system (“GPS”) or some other radio frequency based localization method. In such an embodiment, a station could determine its location on a periodic basis using the GPS system. The station could then share its location with the other stations and use its location when performing interference estimation. This is a particularly good embodiment when the wireless network includes mobile wireless stations, such as laptop computer 94 shown in FIG. 2a. Relying on a GPS system for location information would allow mobile stations to frequently determine and share their location information, so that the stations in the network can make interference estimations using updated location information.

The present invention can be implemented as an enhancement to the IEEE 802.11 protocols. The following describes possible modifications to the IEEE 802.11 protocols that could allow this.

First, the physical carrier sensing mechanism used in the 802.11 standards could be modified. IEEE 802.11 uses a physical carrier sensing mechanism called Clear Channel Assessment (CCA), which tests the carrier to determine if another station is using the carrier. Under normal operation, when the CCA indicator indicates that the carrier is busy, an 802.11 system blocks its transmissions until the CCA mechanism indicates that the carrier is idle. In a station using the interference estimation features of the present invention, the CCA mechanism could be suppressed when the station determines that it can transmit concurrently with another station. One way the station could suppress the CCA mechanism is with a suppression timer called a CCA-Suppression Vector (“CSV”). When a local station determines it can transmit concurrently with a remote station, the local station sets the CSV timer according to, for example, the Duration field of a received RTS, CTS, DATA, or ACK frame. As a result, the CSV timer could run until the whole on-going communication between the sensed remote stations is completed.

In addition to suppressing the 802.11 standard's CCA mechanism, a system implementing this embodiment of the present invention might also need to override the 802.11 standard's virtual carrier sensing mechanism. In a 802.11 device using the optional channel reservation scheme, when a station other than the intended receiver of a frame receives a RTS, CTS, DATA, or ACK message, the station sets an internal timer known as a Network Allocation Vector (“NAV”). This timer acts as an estimation of the remaining time of the remote communication, and the station sets it according to the duration field in the received frame. The duration field contains the frame sender's estimation for how long the whole data frame delivery message exchange sequence (including short interframe space (“SIFS”) waits and the acknowledgement) will take, or in other words, the reserved duration of this data frame delivery. After a station sets the NAV, it may extend the NAV if a newly received frame contains a duration field pointing to a later completion time. To prevent transmitting concurrently with a remote station, a local station normally checks its NAV before attempting to transmit. If the NAV is not zero, the node normally blocks its own transmissions to honor the channel reservations.

A station implementing the interference estimation protocol of the present invention could disable the NAV function when the station determines that it can transmit concurrently with a remote station. To accomplish this, the station would simply only set the NAV when it estimates that a local transmission would interfere with the on-going delivery. If the station estimates that a location transmission would not interfere with the on-going delivery, the station turns the virtual carrier sensing mechanism off by not setting a NAV or by disabling a previously set NAV.

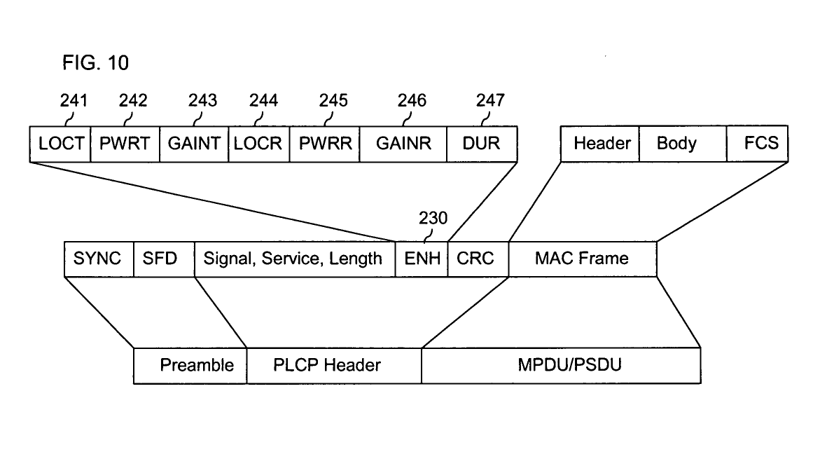

In addition to modifying the physical and virtual carrier sensing mechanisms used in 802.11 compatible devices, the headers could be enhanced to include the parameter information described above. FIG. 10 shows a frame format supporting the present invention. The frame includes a block of information, 230, called Enhanced (“ENH”) that provides the additional information used by stations for interference estimation. In this embodiment, the ENH block is inserted before the true MAC data section. ENH block 230 is divided into seven fields. LOCT field 241 contains the location of the frame transmitter, PWRT field 242 describes the transmission power of the transmitter, and GAINT field 243 specifies the transmission antenna gain. LOCR field 244, PWRR field 245, and GAINR field 246 contain similar pieces of information for the station that is the recipient of the transmission. For 802.11 systems using the optional handshaking scheme, the DUR field, 247, can include a copy of the duration field of the RTS, CTS, DATA, or ACK message.

When a transmitting station has data to send to a receiving station, the transmitting station fills the LOCT, PWRT, and GAINT fields with its own parameters, and it fills the LOCR, PWRR, and GAINR with the destination station's parameters. If these parameters are not known at that time, the station sets them to NULL. Upon receiving the frame, the receiving station copies the LOCT, PWRT, and GAINT fields into the corresponding fields of the frames it sends in reply. The receiving station also fills the LOCR, PWRR, and GAINR fields of the reply frame with its own parameters. If a station does not know a parameter, it could fill the corresponding field with a NULL value.

The present invention can also be implemented in devices that support the capture of a new frame after the receiver has already begun to receive another frame. One example of such a receiver Physical Layer (PHY) design is Lucent's PHY design with “Message-In-A-Message” (MIM) support, which is described in U.S. Pat. No. 5,987,033. In this design, the newly arrived frame is referred to as the “(new) message in the (current) message”.

A MIM receiver is very similar to a normal wireless station receiver, except that it continues to monitor the received signal strength after the PHY transition to the data reception state. If the received signal strength increases significantly during the reception of a frame, the receiver considers that it may have detected the beginning of a MIM frame and hence switches to a special MIM state to handle the new frame. While under the MIM state, the receiver tries to detect a carrier for a new frame. It the carrier signal is detected, the receiver begins to decode the initial portion (namely the preamble) of the new frame and retrains to synchronize with the new transmission. If no carrier is detected, which means the energy increase is caused by noise, the PHY will remain in this MIM state until either a carrier is detected or the scheduled reception termination time for the first frame is reached.

With a MIM capable design, a wireless station is always able to correctly detect and capture a strong frame regardless of the current state of the receiver, unlike other designs where the strong frame can only be correctly detected and captured while the PHY is under certain states during its reception of a weak frame.

The present invention can be used in networks operating in various modes, such as ad-hoc mode, access point mode, or mesh mode. Additionally, the present invention also functions in networks using full or partial mesh topologies.

The many features and advantages of the invention are apparent from this detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of operating a local wireless station comprising:
detecting a remote communication between a transmitting station and a receiving station over a wireless channel;
determining whether a local transmission using the wireless channel would interfere with the remote communication using a model of the capture effects at the receiving station; and
in response to the determination, broadcasting a local transmission over the wireless channel concurrently with a transmission from the transmitting station.

2. The method of claim 1, wherein the model of the capture effects at the receiving station is based on:
a power of a transmission from the transmitting station at the location of the receiving station; and
a power of a transmission from the local station at the location of the receiving station.

3. The method of claim 2, wherein at least one of the powers is calculated using a signal propagation model.

4. The method of claim 3, wherein the signal propagation model is based on information describing the physical location of the receiving station relative to a reference.

5. The method of claim 4, wherein the information is acquired using a radio frequency based localization method.

6. The method of claim 1, wherein the transmitting station transmits a frame that includes a parameter used in the model of the capture effects.

7. The method of claim 6, wherein all frames transmitted by the transmitting station include a field for storing a parameter used in the model of the capture effects.

8. The method of claim 6, wherein the local station stores the parameter in a memory and updates the stored parameter in response to receiving an updated value from the transmitting station.

9. The method of claim 8, wherein the local station performs the determining every time it updates the stored parameter.

10. The method of claim 6, wherein the parameter describes the location of one of the transmitting or receiving stations relative to a reference.

11. An apparatus that performs any one of the methods according to claims 1-10.

12. A computer readable medium storing a program that causes a computer to perform any one of the methods according to claims 1-10.

13. A method of operating a local wireless station, comprising:
detecting a frame transmitted wirelessly from a first wireless station to a second wireless station over a wireless communication channel;
extracting from a header in the frame characteristics of the first and second stations;
based on the extracted characteristics and a signal propagation model, calculating the powers of:
a signal transmitted from the local station at the locations of the first and second stations,
a signal transmitted from the first station at the location of the second station, and
a signal transmitted from the second station at the location of the first station;
estimating whether the signal transmitted from the local station would prevent the first station from capturing a signal transmitted from the second station and would prevent the second station from capturing a signal transmitted from the first station using a capture effect model; and
in response to the estimating, transmitting a frame addressed to a third wireless station over the wireless communication channel concurrently with a transmission from either the first or second stations.
